(19) United States
(12) Patent Application Publication
(10) Pub. No.: US 2019/0213372 A1
(43) Pub. Date: Jul. 11, 2019

(54) ELECTRONIC DEVICE AND FINGERPRINT IDENTIFICATION MODULE THEREOF

(71) Applicant: Primax Electronics Ltd., Taipei City (TW)

(72) Inventor: Chih-Hao Hsu, Taipei City (TW)

(21) Appl. No.: 15/961,379

(22) Filed: Apr. 24, 2018

(30) Foreign Application Priority Data
Jan. 5, 2018 (TW) 107100514

(51) Int. Cl. G06K 9/00; G06F 3/01; G06F 3/044; G06F 3/043; G06F 1/16

(52) U.S. Cl. CPC G06K 9/0002; G06F 3/011; G06F 1/1684; G06F 3/043; G06F 3/044

(57) ABSTRACT

An electronic device includes a casing, a display module and a fingerprint identification module. The display module is disposed on the casing. The fingerprint identification module includes a fingerprint sensor and a pattern layer. The pattern layer is located over the fingerprint sensor. The pattern layer is an ink layer or a coating layer.

### FIELD OF THE INVENTION

The present invention relates to an electronic device, and more particularly to an electronic device with a fingerprint identification module.

### BACKGROUND OF THE INVENTION

Recently, a fingerprint identification module has gradually become an essential component of an electronic device. The fingerprint identification module is used to recognize the identity of the user. Consequently, the user can unlock the electronic device or operates an application program through the fingerprint identification module.

For facilitating the user to use the electronic device, it is important to simplify the input operation of the electronic device. Consequently, the keyboard input module is gradually replaced by the touch input module. In some electronic devices (e.g., smart phones), the display modules with the touch input functions completely replace the uses of keys. In case that the electronic device is not equipped with keys, the fingerprint identification module is usually located under the display module, or the fingerprint identification module is located under a logo or a text symbol on a casing of the electronic device. When the user's finger is placed on the position of the casing corresponding to logo or the text symbol, the fingerprint identification module recognize the identity of the user.

For example, Chinese Patent Publication No. CN106164933A discloses a correcting method, a device and a terminal of fingerprint images. A logo pattern is formed on a cover plate of a fingerprint identification module by a screen printing method. The cover plate and the screen-print layer with the logo pattern are adhered on a fingerprint chip through a glue layer. Since the screen-print layer has irregular bumps and the dielectric constant of the screen-print layer and the dielectric constant of the glue layer are not always equal, the fingerprint sensor of the fingerprint chip cannot accurately obtain the fingerprint image. For obtaining the accurate fingerprint image, it is necessary to perform a correction according to the non-fingerprint image information that is stored in the device during the process of acquiring the fingerprint. However, since the bumps on the logo pattern of the screen-print layer are not completely identical, the correction according to the non-fingerprint image information may result in some errors. Moreover, since different electronic devices are possibly equipped with different logo patterns, it is impossible to use the single non-fingerprint image information to correct the acquired fingerprint.

Therefore, it is important to fabricate an improved fingerprint identification module with a pattern, a text or a symbol. Moreover, it is not necessary to additionally perform the correction during the fingerprint acquiring process. Moreover, the arrangement of the fingerprint identification module does not adversely affect the appearance consistency.

### SUMMARY OF THE INVENTION

The present invention provides a fingerprint identification module with a pattern, a text or a symbol. Moreover, it is not necessary to additionally perform the correction during the fingerprint acquiring process. Moreover, the arrangement of the fingerprint identification module does not adversely affect the appearance consistency.

In accordance with an aspect of the present invention, there is provided an electronic device. The electronic device includes a casing, a display module and a fingerprint identification module. The display module is disposed on the casing. The fingerprint identification module includes a fingerprint sensor and a pattern layer. The pattern layer is located over the fingerprint sensor. The pattern layer is an ink layer or a coating layer.

In an embodiment, the fingerprint identification module further includes a primer layer, at least one color paint layer and a topcoat layer. The primer layer is located over the fingerprint sensor. The at least one color paint layer is located over the primer layer. The topcoat layer is located over the at least one color paint layer.

In an embodiment, the pattern layer is formed on the topcoat layer.

In an embodiment, the pattern layer is arranged between the topcoat layer and the at least one color paint layer.

In an embodiment, the pattern layer is arranged between the at least one color paint layer and the primer layer.

In an embodiment, the pattern layer is arranged between the primer layer and the fingerprint sensor.

In an embodiment, the at least one color paint layer comprises a first color paint layer and a second color paint layer.

In an embodiment, the pattern layer is arranged between the primer layer and the first color paint layer and the second color paint layer.

In an embodiment, the fingerprint sensor is a capacitive fingerprint sensor or an ultrasonic fingerprint sensor.

In an embodiment, the electronic device is a notebook computer, a tablet computer, a personal digital assistant, a smart phone or a game console.

In accordance with another aspect of the present invention, there is provided a fingerprint identification module. The fingerprint identification module includes a fingerprint sensor and a pattern layer. The pattern layer is located over the fingerprint sensor, and the pattern layer is an ink layer or a coating layer.

In an embodiment, the fingerprint identification module further includes a primer layer, at least one color paint layer and a topcoat layer. The primer layer is located over the fingerprint sensor. The at least one color paint layer is located over the primer layer. The topcoat layer is located over the at least one color paint layer.

In an embodiment, the pattern layer is formed on the topcoat layer.

In an embodiment, the pattern layer is arranged between the topcoat layer and the at least one color paint layer.

In an embodiment, the pattern layer is arranged between the at least one color paint layer and the primer layer.

In an embodiment, the pattern layer is arranged between the primer layer and the fingerprint sensor.

In an embodiment, the at least one color paint layer comprises a first color paint layer and a second color paint layer.

In an embodiment, the pattern layer is arranged between the primer layer and the first color paint layer and the second color paint layer.

In an embodiment, the fingerprint sensor is a capacitive fingerprint sensor or an ultrasonic fingerprint sensor.

The above objects and advantages of the present invention will become more readily apparent to those ordinarily skilled in the art after reviewing the following detailed description and accompanying drawings, in which:

### BRIEF DESCRIPTION OF THE DRAWINGS

FIG 1A is a schematic side view illustrating an electronic device according to an embodiment of the present invention;

FIG. 1B is a schematic front view illustrating the electronic device according to the embodiment of the present invention;

FIG. 1C is a schematic rear view illustrating the electronic device according to the embodiment of the present invention;

FIG. 2 is a schematic cross-sectional view illustrating a fingerprint identification module according to a first embodiment of the present invention;

FIG. 3 is a schematic cross-sectional view illustrating a fingerprint identification module according to a second embodiment of the present invention;

FIG. 4 is a schematic cross-sectional view illustrating a fingerprint identification module according to a third embodiment of the present invention;

FIG. 5 is a schematic cross-sectional view illustrating a fingerprint identification module according to a fourth embodiment of the present invention;

FIG. 6 is a schematic cross-sectional view illustrating a fingerprint identification module according to a fifth embodiment of the present invention;

FIG. 7 is a schematic cross-sectional view illustrating a fingerprint identification module according to a sixth embodiment of the present invention;

FIG. 8 is a schematic cross-sectional view illustrating a fingerprint identification module according to a seventh embodiment of the present invention;

FIG. 9 is a schematic cross-sectional view illustrating a fingerprint identification module according to an eighth embodiment of the present invention; and

FIG. 10 is a schematic cross-sectional view illustrating a fingerprint identification module according to a ninth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

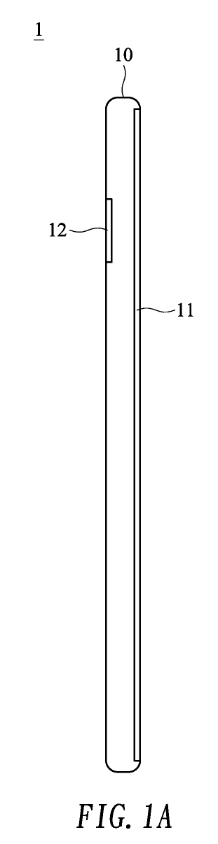

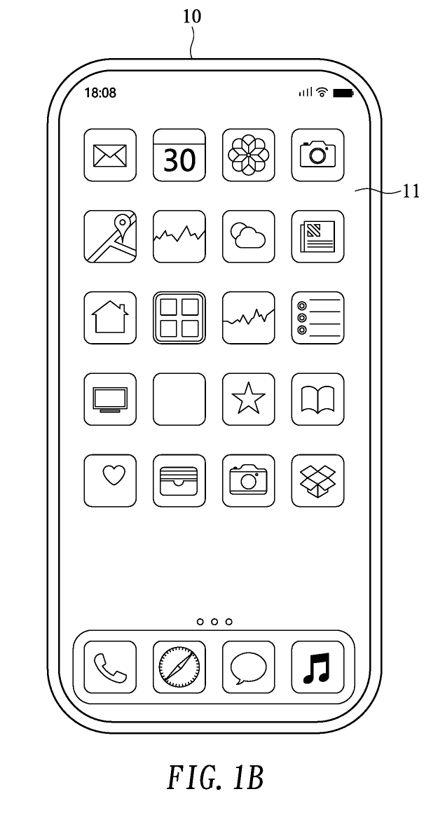

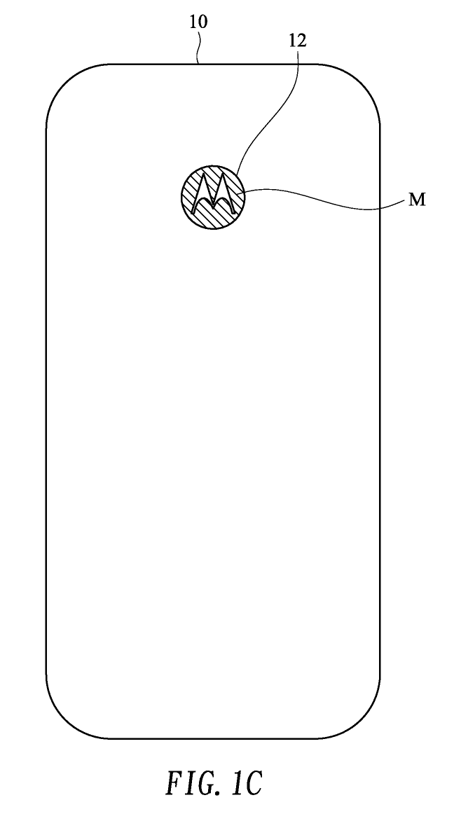

Please refer to FIGS. 1A, 1B and 1C. FIG 1A is a schematic side view illustrating an electronic device according to an embodiment of the present invention. FIG. 1B is a schematic front view illustrating the electronic device according to the embodiment of the present invention. FIG. 1C is a schematic rear view illustrating the electronic device according to the embodiment of the present invention.

As shown in FIG. 1, the electronic device 1 comprises a casing 10, a display module 11 and a fingerprint identification module 12. The display module 11 is disposed on a front surface of the casing 10. The fingerprint identification module 12 is disposed on a rear surface of the casing 10. That is, the fingerprint identification module 12 and the display module 11 are opposite to each other. An example of the electronic device 10 includes but is not limited to a personal digital assistant (PDA) or a smart phone.

Please refer to FIG. 1B. The display module 11, which is disposed on a front surface of the casing 10, has a touch input function and shows an operation interface. By touching the display module 11, the user can operate the electronic device 10. For example, the display module 11 is a liquid crystal display (LCD), a light emitting diode (LED) display device or a field emission display (FED) that has a touch control function. The touch control function includes a resistive touch control function, a capacitive touch function, an acoustic-wave touch control function or an electromagnetic control function.

Please refer to FIG. 1C. The fingerprint identification module 12, which is disposed on the rear surface of the casing 10, has a pattern layer M. A pattern, a text or a symbol is shown on the pattern layer M. For example, a logo of the electronic device 1 is shown on the pattern layer M. When the user's finger is placed on the fingerprint identification module 12 at the position corresponding to the pattern layer M, the fingerprint identification module 12 recognizes the identity of the user. Consequently, the user can unlock the electronic device 1 or operates an application program through the fingerprint identification module 12.

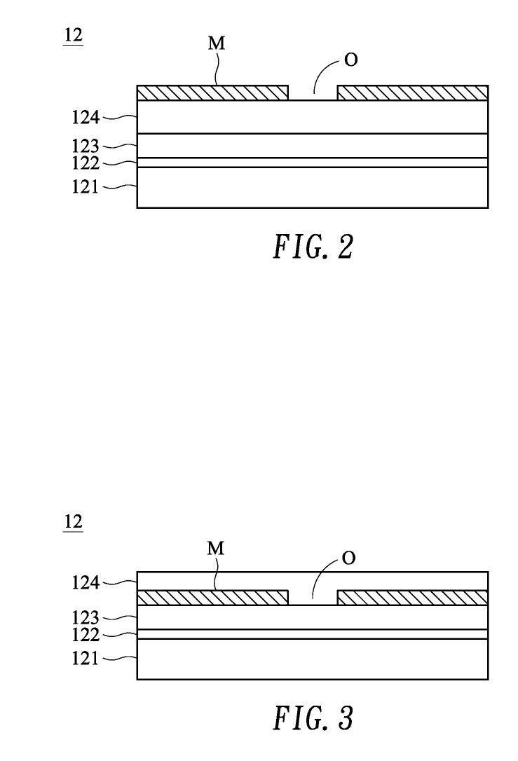

FIG. 2 is a schematic cross-sectional view illustrating a fingerprint identification module according to a first embodiment of the present invention. As shown in FIG. 2, the fingerprint identification module 12 comprises a fingerprint sensor 121, a primer layer 122, a color paint layer 123 and a topcoat layer 124, which are stacked on each other from bottom to top. The fingerprint sensor 121 is used for sensing the fingerprint information of the user's finger. For example, the fingerprint sensor 121 is a capacitive fingerprint sensor or an ultrasonic fingerprint sensor. The primer layer 122 is coated on a surface of the fingerprint sensor 121 in order to increase the adhesion between the color paint layer 123 and the fingerprint sensor 121. That is, the color paint layer 123 and the fingerprint sensor 121 are combined together more easily through the primer layer 122. The color paint layer 123 exhibits the base tone or gloss of the appearance of the fingerprint identification module 12. The topcoat layer 124 is formed on the color paint layer 123. The topcoat layer 124 is used as a protective layer that can be pressed by the user's finger. Preferably, each of the primer layer 122, the color paint layer 123 and the topcoat layer 124 are made of optically-cured resin, thermally-cured resin or a mixture of the optically-cured resin and the thermally-cured resin. The thickness of the primer layer 122 is in the range between 1 μm and 5 μm. The thickness of the color paint layer 123 is in the range between 10 μm and 20 μm. The thickness of the topcoat layer 124 is in the range between 10 μm and 20 μm. For example, after an ink material is coated on the topcoat layer 124 by a screen printing process, the pattern layer M is formed. The thickness of the pattern layer M is in the range between 5 μm and 7 μm. Moreover, the pattern layer M has a hollow portion O. The base tone or gloss of the color paint layer 123 is exposed outside through the hollow portion O. Consequently, a pattern, a text or a symbol that can be recognized by the user is generated.

FIG. 3 is a schematic cross-sectional view illustrating a fingerprint identification module according to a second embodiment of the present invention. The structures and functions of the fingerprint sensor 121, the primer layer 122, the color paint layer 123 and the topcoat layer 124 of the fingerprint identification module 12 of this embodiment are similar to those of FIG. 2, and are not redundantly described herein. In comparison with FIG. 2, the pattern layer M of this embodiment is arranged between the topcoat layer 124 and the color paint layer 123. For example, after an ink material is coated on the color paint layer 123 by a screen printing process, the pattern layer M is formed. The thickness of the pattern layer M is in the range between 5 μm and 7 μm. Alternatively, after a metallic coating material or a nonmetallic coating material is deposited or sputtered on the color paint layer 123 by a vacuum metallization (VM) process such as a non-conductive optical coating (NCOC) process, the pattern layer M is formed. For example, the nonmetallic coating material is a composite material comprising TiO₂, Nb₂O₅, Ta₂O₅, ZrO₂, Y₂O₃, SiO₂, MgF₂, MgO or Al₂O₃. In case that the pattern layer M is a single-layered coating film or a multi-layer composite coating film produced by the vacuum metallization process, the thickness of the pattern layer M is smaller than 1 μm. Since the thickness of the pattern layer M is smaller than 1 μm, the pattern layer M produced by the vacuum metallization process is nonconductive. Due to the nonconductive property of the pattern layer M, the capability of the fingerprint sensor 121 to transmit and receive signals is not interfered. Moreover, after the light beam is transmitted through the topcoat layer 124 and irradiated on the pattern layer M, the reflected light from the coating film produces constructive interference or destructive interference according to the thickness of the coating film or the material composition difference. Consequently, the pattern layer M produces different gloss or color effects. For example, the pattern layer M produces a metallic visual effect. Similarly, the pattern layer M has a hollow portion O. Consequently, a pattern, a text or a symbol that can be recognized by the user is generated through the hollow portion O. Moreover, the recognition degree of the pattern, the text or the symbol is enhanced through the gloss or color effect that is generated by the pattern layer M itself.

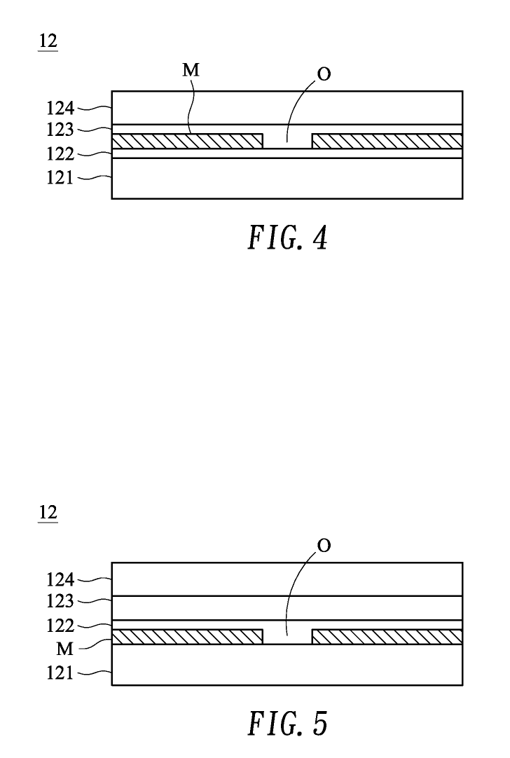

FIG. 4 is a schematic cross-sectional view illustrating a fingerprint identification module according to a third embodiment of the present invention. The structures and functions of the fingerprint sensor 121, the primer layer 122, the color paint layer 123 and the topcoat layer 124 of the fingerprint identification module 12 of this embodiment are similar to those of FIG. 3, and are not redundantly described herein. In comparison with FIG. 3, the pattern layer M of this embodiment is arranged between the color paint layer 123 and the primer layer 122. For example, after a metallic coating material or a nonmetallic coating material is deposited or sputtered on the primer layer 122 by a vacuum metallization (VM) process such as a non-conductive optical coating (NCOC) process, the pattern layer M is formed. In case that the pattern layer M is a single-layered coating film or a multi-layer composite coating film produced by the vacuum metallization process, the thickness of the pattern layer M is smaller than 1 μm.

FIG. 5 is a schematic cross-sectional view illustrating a fingerprint identification module according to a fourth embodiment of the present invention. The structures and functions of the fingerprint sensor 121, the primer layer 122, the color paint layer 123 and the topcoat layer 124 of the fingerprint identification module 12 of this embodiment are similar to those of FIG. 4, and are not redundantly described herein. In comparison with FIG. 4, the pattern layer M of this embodiment is arranged between the primer layer 122 and the fingerprint sensor 121. For example, after a metallic coating material or a nonmetallic coating material is deposited or sputtered on the fingerprint sensor 121 by a vacuum metallization (VM) process such as a non-conductive optical coating (NCOC) process, the pattern layer M is formed. In case that the pattern layer M is a single-layered coating film or a multi-layer composite coating film produced by the vacuum metallization process, the thickness of the pattern layer M is smaller than 1 μm.

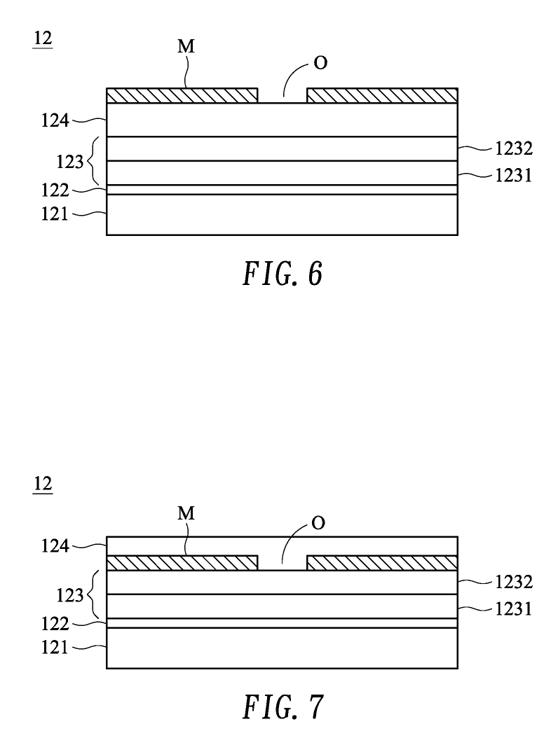

FIG. 6 is a schematic cross-sectional view illustrating a fingerprint identification module according to a fifth embodiment of the present invention. The structures and functions of the fingerprint sensor 121, the primer layer 122 and the topcoat layer 124 of the fingerprint identification module 12 of this embodiment are similar to those of FIG. 2, and are not redundantly described herein. In comparison with FIG. 2, the pattern layer M of this embodiment comprises at least one color paint layer 123. The at least one color paint layer 123 comprises a first color paint layer 1231 and a second color paint layer 1232. The second color paint layer 1232 is formed over the first color paint layer 1231. For example, after an ink material is coated on the topcoat layer 124 by a screen printing process, the pattern layer M is formed. The thickness of the pattern layer M is in the range between 5 μm and 7 μm. Moreover, the pattern layer M has a hollow portion O. The composite base tone or gloss of the first color paint layer 1231 and the second color paint layer 1232 can be exposed outside through the hollow portion O. Consequently, a pattern, a text or a symbol that can be recognized by the user is generated.

FIG. 7 is a schematic cross-sectional view illustrating a fingerprint identification module according to a sixth embodiment of the present invention. The structures and functions of the fingerprint sensor 121, the primer layer 122, the at least one color paint layer 123 and the topcoat layer 124 of the fingerprint identification module 12 of this embodiment are similar to those of FIG. 6, and are not redundantly described herein. In comparison with FIG. 6, the pattern layer M of this embodiment is arranged between the topcoat layer 124 and the at least one color paint layer 123. For example, after an ink material is coated on the color paint layer 123 by a screen printing process, the pattern layer M is formed. The thickness of the pattern layer M is in the range between 5 μm and 7 μm. Alternatively, after a metallic coating material or a nonmetallic coating material is deposited or sputtered on the at least one color paint layer 123 by a vacuum metallization (VM) process such as a non-conductive optical coating (NCOC) process, the pattern layer M is formed. In case that the pattern layer M is a single-layered coating film or a multi-layer composite coating film produced by the vacuum metallization process, the thickness of the pattern layer M is smaller than 1 μm.

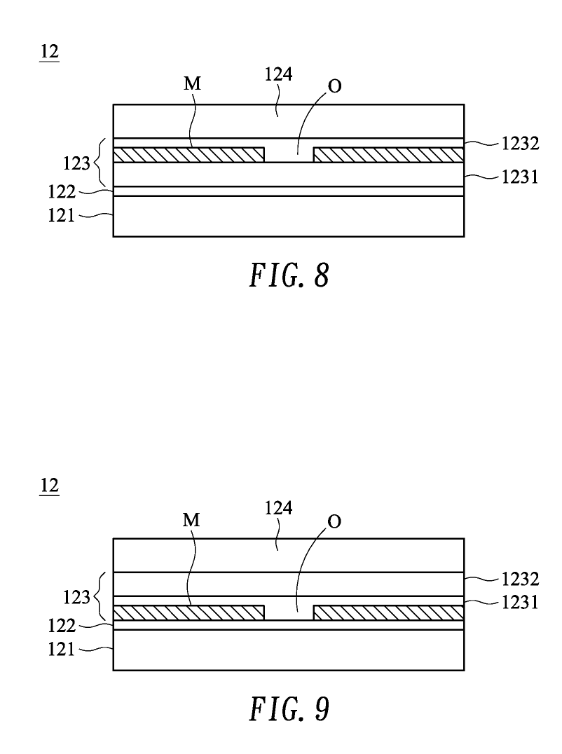

FIG. 8 is a schematic cross-sectional view illustrating a fingerprint identification module according to a seventh embodiment of the present invention. The structures and functions of the fingerprint sensor 121, the primer layer 122, the at least one color paint layer 123 and the topcoat layer 124 of the fingerprint identification module 12 of this embodiment are similar to those of FIG. 7, and are not redundantly described herein. In comparison with FIG. 7, the pattern layer M of this embodiment is arranged between the second color paint layer 1232 and the first color paint layer 1231. For example, after a metallic coating material or a nonmetallic coating material is deposited or sputtered on the first color paint layer 1231 by a vacuum metallization (VM) process such as a non-conductive optical coating (NCOC) process, the pattern layer M is formed. In case that the pattern layer M is a single-layered coating film or a multi-layer composite coating film produced by the vacuum metallization process, the thickness of the pattern layer M is smaller than 1 μm.

FIG. 9 is a schematic cross-sectional view illustrating a fingerprint identification module according to an eighth embodiment of the present invention. The structures and functions of the fingerprint sensor 121, the primer layer 122, the at least one color paint layer 123 and the topcoat layer 124 of the fingerprint identification module 12 of this embodiment are similar to those of FIG. 8, and are not redundantly described herein. In comparison with FIG. 8, the pattern layer M of this embodiment is arranged between the first color paint layer 1231 and the primer layer 122. For example, after a metallic coating material or a nonmetallic coating material is deposited or sputtered on the primer layer 122 by a vacuum metallization (VM) process such as a non-conductive optical coating (NCOC) process, the pattern layer M is formed. In case that the pattern layer M is a single-layered coating film or a multi-layer composite coating film produced by the vacuum metallization process, the thickness of the pattern layer M is smaller than 1 μm.

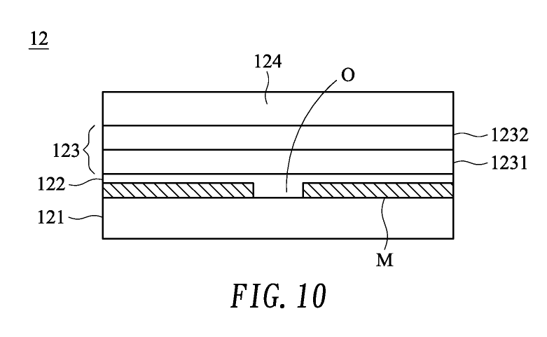

FIG. 10 is a schematic cross-sectional view illustrating a fingerprint identification module according to a ninth embodiment of the present invention. The structures and functions of the fingerprint sensor 121, the primer layer 122, the at least one color paint layer 123 and the topcoat layer 124 of the fingerprint identification module 12 of this embodiment are similar to those of FIG. 9, and are not redundantly described herein. In comparison with FIG. 9, the pattern layer M of this embodiment is arranged between the primer layer 122 and the fingerprint sensor 121. For example, after a metallic coating material or a nonmetallic coating material is deposited or sputtered on the fingerprint sensor 121 by a vacuum metallization (VM) process such as a non-conductive optical coating (NCOC) process, the pattern layer M is formed. In case that the pattern layer M is a single-layered coating film or a multi-layer composite coating film produced by the vacuum metallization process, the thickness of the pattern layer M is smaller than 1 μm.

As mentioned above, the fingerprint identification module of the present invention can be applied to a personal digital assistant or a smart phone. It is noted that the applications of the fingerprint identification module are not restricted. For example, the fingerprint identification module can also be applied to a notebook computer, a tablet computer or a game console or any other computer peripheral device (such as a display screen, a keyboard, a mouse, a stereo device, a printer or an office machine).

From the above descriptions, the present invention provides the fingerprint identification module with a pattern, a text or a symbol. The pattern layer is directly formed over the fingerprint sensor by a screen printing process or a vacuum metallization process. The produced pattern layer is a flat structure and has a small thickness. Consequently, it is not necessary to additionally perform the correction during the fingerprint acquiring process. Moreover, since the fingerprint identification module and the pattern layer are combined together, the user can realize the position to place the finger during the fingerprint recognizing process. Moreover, the arrangement of the fingerprint identification module does not adversely affect the appearance consistency. In other words, the fingerprint identification module of the present invention is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. An electronic device, comprising:
a casing;
a display module disposed on the casing; and
a fingerprint identification module disposed on the casing, comprising a fingerprint sensor and a pattern layer, wherein the pattern layer is located over the fingerprint sensor, and the pattern layer is an ink layer or a coating layer.

2. The electronic device according to claim 1, wherein the fingerprint identification module further comprises:
a primer layer located over the fingerprint sensor;
at least one color paint layer located over the primer layer; and
a topcoat layer located over the at least one color paint layer.

3. The electronic device according to claim 2, wherein the pattern layer is formed on the topcoat layer.

4. The electronic device according to claim 2, wherein the pattern layer is arranged between the topcoat layer and the at least one color paint layer.

5. The electronic device according to claim 2, wherein the pattern layer is arranged between the at least one color paint layer and the primer layer.

6. The electronic device according to claim 2, wherein the pattern layer is arranged between the primer layer and the fingerprint sensor.

7. The electronic device according to claim 2, wherein the at least one color paint layer comprises a first color paint layer and a second color paint layer.

8. The electronic device according to claim 2, wherein the pattern layer is arranged between the primer layer and the first color paint layer and the second color paint layer.

9. The electronic device according to claim 1, wherein the fingerprint sensor is a capacitive fingerprint sensor or an ultrasonic fingerprint sensor.

10. The electronic device according to claim 1, wherein the electronic device is a notebook computer, a tablet computer, a personal digital assistant, a smart phone or a game console.

11. A fingerprint identification module, comprising:
a fingerprint sensor; and
a pattern layer, wherein the pattern layer is located over the fingerprint sensor, and the pattern layer is an ink layer or a coating layer.

12. The fingerprint identification module according to claim 11, further comprising:
a primer layer located over the fingerprint sensor;
at least one color paint layer located over the primer layer; and
a topcoat layer located over the at least one color paint layer.

13. The fingerprint identification module according to claim 12, wherein the pattern layer is formed on the topcoat layer.

14. The fingerprint identification module according to claim 12, wherein the pattern layer is arranged between the topcoat layer and the at least one color paint layer.

15. The fingerprint identification module according to claim 12, wherein the pattern layer is arranged between the at least one color paint layer and the primer layer.

16. The fingerprint identification module according to claim 12, wherein the pattern layer is arranged between the primer layer and the fingerprint sensor.

17. The fingerprint identification module according to claim 12, wherein the at least one color paint layer comprises a first color paint layer and a second color paint layer.

18. The fingerprint identification module according to claim 12, wherein the pattern layer is arranged between the primer layer and the first color paint layer and the second color paint layer.

19. The fingerprint identification module according to claim 11, wherein the fingerprint sensor is a capacitive fingerprint sensor or an ultrasonic fingerprint sensor.
